(19) United States
(12) Patent Application Publication
(10) Pub. No.: US 2008/0053266 A1
(43) Pub. Date: Mar. 6, 2008

(54) BICYCLE HANDLEBAR

(75) Inventor: Hans- Christian Smolik, Freinberg-Marklkofen (DE)

Correspondence Address: CLEMENTS WALKER, 1901 ROXBOROUGH ROAD, SUITE 300, CHARLOTTE, NC, 28211, US

(73) Assignee: CANYON BICYCLES GMBH, Koblenz (DE)

(21) Appl. No.: 11/846,654

(22) Filed: Aug. 29, 2007

(30) Foreign Application Priority Data
Aug. 30, 2006 (DE) 20 2006 013 277.5

(51) Int. Cl. B62K 21/12

(52) U.S. Cl. 74/551.8

(57) ABSTRACT

A bicycle handlebar, which is in particular a racing bicycle handlebar, comprises a transverse member (12) extending transversely to the driving direction (16). Said transverse member (12) is connected with two gripping members (14,21). For improving the aerodynamics, an aerodynamically configured liquid storage container (10,42) is in particular releasably connected with said transverse member (12).

### BACKGROUND OF THE INVENTION

1. Field of the Invention

The present invention relates to a bicycle handlebar, and in particular to a racing bicycle handlebar.

2. Description of Related Art

Sporty cycling, in particular riding a racing bicycle, requires a liquid to be taken along. It is common practice to arrange a drinking bottle in a holder normally fastened to the down tube or the seat tube.

In particular in the case of racing bicycles it is not only necessary that the bicycle has as low a weight as possible, but the bicycle must be configured as aerodynamically as possible. Arrangement of drinking bottles and drinking bottle holders at the down or seat tube of the bicycle frame considerably affects the aerodynamics.

### SUMMARY OF THE INVENTION

It is an object of the present invention to improve the aerodynamics of bicycles, in particular of racing bicycles, wherein especially the negative effects on the aerodynamics provoked by drinking bottles are to be reduced.

According to the invention, a liquid storage container is connected with the bicycle handlebar. The bicycle handlebar comprises a transverse member, i.e. a component arranged transversely to the driving direction. This transverse member has connected therewith two gripping members. According to the invention, the liquid storage container is of aerodynamic configuration and is connected with the transverse member. Arrangement of the liquid storage container at the handlebar offers the advantage that the shape of the liquid storage container can be selected such that said liquid storage container exerts as little influence as possible on the aerodynamics. Influences affecting the aerodynamics, such as whirls or the like, caused by drinking bottles arranged at the down or seat tube can thus be prevented. This considerably improves the aerodynamics of the bicycle. Further, arrangement of the liquid storage container in the region of the handlebar offers the advantage that said container possibly need not be taken out of a holder, but a drinking straw or the like can be immediately connected with the liquid storage container. Thus, liquid can be consumed in an extremely convenient manner during the ride.

Preferably, the liquid storage container is arranged transversely to the driving direction. Thus the transverse dimensions of the liquid storage container, i.e. the dimensions in horizontal direction, are larger than the dimensions in vertical direction. In longitudinal direction of the bicycle frame, i.e. in the driving direction, the dimensions of the liquid storage container are preferably also smaller than the transverse dimensions relative to the driving direction. In particular, the transverse member of the bicycle handlebar is longer as seen in the driving direction than perpendicularly to the driving direction, i.e. in vertical direction. The transverse member is thus of elongate configuration relative to the driving direction. Preferably, the liquid storage container at least partly covers the transverse member as seen in the driving direction. In particular, the liquid storage container substantially completely covers the transverse member in the driving direction. In a preferred embodiment, the liquid storage container and the transverse member are configured such that the liquid storage container and the transverse member define a unit of aerodynamic design relative to the driving direction. With regard to the transverse member this is of preference only in that region in which the transverse member is covered by the liquid storage container.

The liquid storage container, which preferably is releasably connected with the transverse member, can be connected with the transverse member at different sides, wherein it is preferred that the liquid storage container is generally arranged at a lower side of the transverse member.

In a particular preferred embodiment, a transverse side of the transverse member, i.e. a transverse member side extending transversely to the driving direction, steplessly transitions into a transverse side of the liquid storage container. In particular, the stepless transition takes place between a transverse side of the transverse member and a transverse side of the liquid storage container at the front side of the transverse member. Here, the liquid storage container preferably covers the front side of the transverse member. In particular, the liquid storage container may be configured such that it embraces the front side of the transverse member. In the connected state, i.e. when the liquid storage container is connected with the transverse member of the bicycle handlebar, the transverse member, together with the liquid storage container, has an aerodynamic, in particular drop-shaped cross section. In a drop-shaped cross section, the tip of the drop preferably points rearwards as seen in the driving direction.

Preferably, the transition between the transverse member and the liquid storage container is stepless not only at a front and upper side, but also at a rear side in order to prevent whirls and realize a favorable aerodynamic configuration. In another preferred embodiment, the rear side of the transverse member and/or the liquid storage container comprises a break-off edge. In particular, the break-off edge may be configured as a common region in which the transverse member contacts the liquid storage container.

Preferably, the transverse member itself is of aerodynamic, in particular drop-shaped configuration such that good aerodynamics is ensured even when the bicycle is used without the liquid storage container.

For withdrawing the liquid, the liquid storage container preferably comprises an opening for insertion of a drinking straw or the like. Preferably, the opening is arranged near the handlebar stem for allowing convenient drinking during the ride.

For releasably fastening the liquid storage container at the transverse member, snap-in clamping members are provided, for example. This configuration may however provoke slight whirls such that in a particularly preferred embodiment a fastening means integrated in an opening of the transverse member is provided. For example, the fastening means comprises a threaded pin which is connected with the liquid storage container in a central region, i.e. in a region of the handlebar stem. Said threaded pin extends through an opening in the transverse member such that a nut allows the liquid storage container to be fixed to the transverse member. Of course, the pin may comprise a snap-in member, a bayonet catch or the like instead of a thread. The holding member configured as a nut, screw or the like, for example, is preferably arranged in a recess of the transverse member so as not to affect the aerodynamics.

In another preferred embodiment, the opening for insertion of the drinking straw or the like is integrated in the fastening means. This may facilitate the manufacture and prevent negative influences on the aerodynamics provoked by the drinking straw opening. For example, a pin of the fastening means, which extends into an opening of the transverse member, is of hollow configuration such that the drinking straw can pass through said pin.

In a particularly preferred aspect, the shape of the liquid storage container is selected such that a collecting zone is defined in which the entire liquid accumulates. The drinking straw preferably ends in this zone. The inside of the liquid storage container is preferably configured such that dead zones in which liquid accumulates are prevented. The inside is rather configured such that the entire liquid flows into the collecting zone.

In another preferred embodiment, which helps to further improve the aerodynamics of the handlebar, the stem serving for fastening the handlebar to the fork tube is integrally formed with the transverse member. In particular, for weight-saving purposes, the handlebar is made from a fiber composite material, in particular a carbon fiber material. The integral configuration of the transverse member and the stem is an independent invention independent of the feature of connecting a liquid storage container with the bicycle handlebar.

Preferably, the stem comprises an insertion opening for inserting shifter and/or brake cables and/or corresponding conduits such that the cables and/or the conduits can run inside the handlebar to the shifters or brake levers.

### BRIEF DESCRIPTION OF THE DRAWINGS

Embodiments of the invention will now be described in greater detail with reference to the drawings in which:

FIG. 1 shows a schematic top view of a handlebar according to the invention, wherein the illustrated embodiment is a so-called triathlon bicycle handlebar,

FIG. 2 shows a schematic front view as seen in the direction of arrow II of FIG. 1,

FIG. 3 shows a schematic cross-sectional view along line III-III of FIG. 2, and

FIG. 4 shows a schematic front view of a second preferred embodiment.

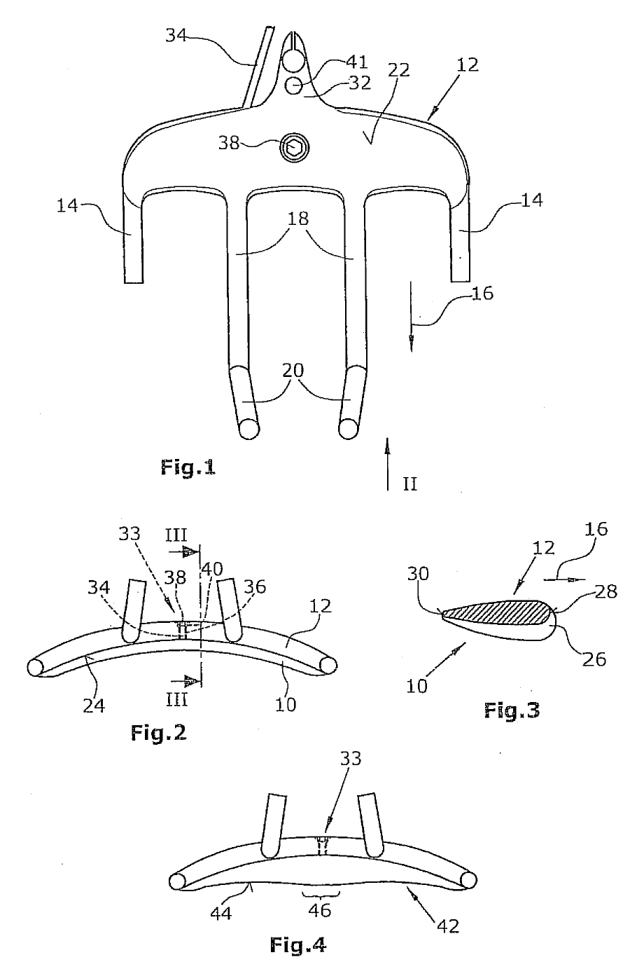

### DETAILED DESCRIPTION OF THE PREFERRED EMBODIMENTS OF THE INVENTION

A bicycle handlebar comprising an integrated liquid storage container 10 according to the invention is a so-called triathlon bicycle handlebar, for example. Said handlebar comprises, like a racing bicycle handlebar or a conventional bicycle handlebar, a transverse member 12. The outer sides of the transverse member 12 have connected therewith gripping members 14 which are usually provided with brake handles. Between the two gripping members 14 bars 18 extending longitudinally as seen in the driving direction 16 are connected with the transverse member 12. At the free ends of the longitudinal bars 18 upwardly inclined gripping members 20 are provided. The free ends of the gripping members 20 usually have connected therewith a shifter member. At an upper side 22 of the transverse member 12 supporting members not shown for the forearms may be additionally provided. The forearms are supported on the supporting members when the driver grips the gripping members 20. In the illustrated embodiment, the transverse member 12 has a height which is smaller than its extension as seen in the driving direction 16. The transverse member 12 has a drop-shaped cross section (FIG. 3) such that the transverse member 12 offers good aerodynamics even when the liquid storage container 10 is not connected with the transverse member 12.

At a lower side 24 of the transverse member 12 the liquid storage container 10 is provided. A front region 26 (FIG. 3) of the liquid storage container 10 pointing in the driving direction 16 embraces a front side 28 of the transverse member 12. As can be seen in FIG. 3, the liquid storage container 10 is in particular configured such that said container, together with the transverse member 12, has a drop-shaped cross section.

Instead of being fastened at the lower side 24, which is a transverse side, the liquid storage container 10 may be fastened at another transverse side, such as the upper side 22 or the front side 28 of the transverse member 12.

The transition between the transverse member 12 and the liquid storage container 10 is smooth, i.e. stepless. Thus whirls in this region are prevented. At a rear side 30 another stepless smooth transition is preferably provided between the transverse member 12 and the liquid storage container 10. A break-off edge for breaking off the air flow across the upper side and the lower side of the handlebar may be provided in this region.

In the illustrated embodiment, the liquid storage container 10 further comprises an opening arranged beside a handlebar stem 32, through which opening the drinking straw can be inserted into the liquid storage container 10.

For fixing the liquid storage container 10 at the transverse member 12 a fastening means 33 is provided which, in a preferred embodiment, comprises a threaded pin 34 connected with an upper side of the liquid storage container 10. The threaded pin 34 extends into an opening 36 of the transverse bar 12. For fixing purposes, a nut 38 is provided which is arranged in a recess 40 of the transverse member such that the aerodynamics is affected only to a minimal degree.

The transverse member 12 is of arcuate configuration as seen from the front (FIG. 2) such that the gripping members 14 are arranged at a lower level than the longitudinal bars 18 disposed further inside, at which longitudinal bars the upwardly inclined gripping members 20 are provided. This configuration allows the driver to shift his weight to as small an extent as possible when moving his hands from the gripping members 14 to the gripping members 20 or vice versa.

In the handlebar stem 32 which, in a particularly preferred embodiment, is integrally formed with the transverse member 12 an opening 41 is provided through which the brake and shifter cables can be guided.

In another preferred embodiment (FIG. 4) similar and identical components are identified by the same reference numerals.

The embodiment shown in FIG. 4 only differs from the embodiment described above in that the liquid storage container 42 has a different configuration. In contrast to the liquid storage container 10, the liquid storage container 42 does not have substantially the same cross section across its overall width, in particular not the same height. The liquid storage container rather comprises an essentially horizontal lower side 44 with a deepened portion in its central region such that a collecting region 46 is defined. The collecting region 46, in which the liquid contained in the liquid storage container 42 accumulates at least when the driver drives straight on, is preferably arranged opposite the fastening means 33. In this embodiment the fastening means 33 is preferably configured such that the drinking straw extends through the fastening means 33 and/or the cylindrical, in particular threaded pin 34. The embodiment of the liquid storage container shown in FIG. 4 preferably also has a drop-shaped cross section.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A bicycle handlebar, in particular a racing bicycle handlebar, comprising
a transverse member (12) arranged transversely to the driving direction, said transverse member (12) being connected with two gripping members (14),
wherein said transverse member (12) has connected therewith an aerodynamically configured liquid storage container (10,42) arranged transversely to the driving direction.

2. The bicycle handlebar according to claim 1, wherein the liquid storage container (10,42) is releasably connected with the transverse member (12).

3. The bicycle handlebar according to claim 1, wherein a transverse side (28) of the transverse member (12) steplessly transitions into a transverse side of the liquid storage container (10).

4. The bicycle handlebar according to claim 1, wherein the transverse member (12), connected with the liquid storage container (10,42), has an aerodynamic, in particular drop-shaped cross section.

5. The bicycle handlebar according to claim 1, wherein the transverse member (12) has an aerodynamic, in particular drop-shaped cross section.

6. The bicycle handlebar according to claim 1, wherein a rear side (30) of the transverse member (12) steplessly transitions into a rear side of the liquid storage container (10,42).

7. The bicycle handlebar according to claim 1, wherein the rear side (30) of the transverse member (12) and/or the liquid storage container (10,42) comprises a break-off edge.

8. The bicycle handlebar according to claim 1, wherein an opening for inserting a drinking straw (34) is provided in the liquid storage container (10,42).

9. The bicycle handlebar according to claim 1, wherein a fastening means (33) for fastening the liquid storage container (10,42) is arranged at the transverse member (12).

10. The bicycle handlebar according to claim 8, wherein the drinking straw opening is integrated in the fastening means (33).

11. The bicycle handlebar according to claim 1, wherein a collecting region (46) is provided in which the entire liquid contained in the liquid storage container (42) accumulates.

12. The bicycle handlebar according to claim 1, wherein the transverse member (12) is formed integrally with a handlebar stem (32).

13. The bicycle handlebar according to claim 12, wherein the stem (32) comprises an insertion opening (41) for inserting shifter and/or brake cables.
